(19) United States
(12) Patent Application Publication
(10) Pub. No.: US 2023/0192970 A1
(43) Pub. Date: Jun. 22, 2023

(54) PROCESS FOR OBTAINING A POLYMERIC MATERIAL INCORPORATING METAL PARTICLES

(71) Applicants: Valérie BENSOUSSAN, ENGHIEN LES BAINS (FR); ETHEL LABBOUZ-COHEN, MIAMI BEACH, FL (US)

(72) Inventors: VALERIE BENSOUSSAN, ENGHIEN LES BAINS (FR); ETHEL LABBOUZ-COHEN, MIAMI BEACH, FL (US)

(21) Appl. No.: 17/926,586

(22) PCT Filed: May 19, 2021
(86) PCT No.: PCT/EP2021/063388

§ 371 Date: Nov. 19, 2022

(30) Foreign Application Priority Data
May 19, 2020 (FR) FR2005351

(51) Int. Cl. C08J 3/20; C08K 3/08

(52) U.S. Cl. CPC C08J 3/20; C08K 3/08; C08K 2003/0806

(57) ABSTRACT

The present invention relates to a method for obtaining a polymeric material incorporating metallic particles, a polymeric material incorporating metallic particles and the use of said polymeric material.

The present invention relates to a method for obtaining a polymeric material incorporating metallic particles, a polymeric material incorporating metallic particles and the use of said polymeric material.

It is known to use metal particles in order to improve the properties of a material. By way of example, silver nanoparticles are used to confer bactericidal properties.

However, the use of metal particles, in particular on a nanoscale, in everyday objects is controversial, in particular because of the risk of said particles being released without any control as to their quantity and at the time of release. Thus, particles can be released into the environment and have serious consequences, particularly in aquatic environments.

In addition, the metal particles also have the disadvantage of modifying the color of the material on which they are deposited. Thus, it is not possible to dye such a material other than with dark colors, let alone to keep the original transparency of the material. There is therefore a need for developing a simple and rapid method which makes it possible to incorporate metal particles, in particular into a polymeric material, in an efficient manner, i.e., without the metal particles might being released from the material into which they are incorporated.

It would also be advantageous to develop a method which makes it possible to obtain a material incorporating metal particles, without the intrinsic properties of said material being altered, in particular its color or its transparency.

Inventors developed a method responding to these problems. As a matter of fact, the inventors have observed, that an acid treatment of metal particles before their mixing with a polymer makes it surprisingly possible to obtain a polymeric material in which said particles are incorporated inside the material, and not on the surface.

This simple and rapid method leads to a material in which the metal particles are efficiently incorporated, thus having the advantage of withstanding the various treatments of daily life, such as washing, drying, use of detergents or bleach.

In addition, the material incorporating the metal particles retains all its properties, such as, for example, its transparency or its ability to be dyed by various colors, even light. This method also has the advantage of being applicable directly to market available metallic particles available.

Furthermore, the treated metal particles obtained by the method the invention are stable and, in particular, can be stored in open air for at least 5 days without affecting the following steps of the method.

The invention therefore relates to a method for obtaining a polymeric material incorporating metal particles comprising a step of acid treatment of said metal particles and a step of mixing the treated metal particles with at least one polymer or prepolymer. The term “polymeric material” shall be construed as a material in a solid state at room temperature comprising at least one polymer. According to the invention, the polymeric material is a (mixture of) polymer(s) in which metal particles are incorporated, within the mass of the (mixture of) polymer(s). In particular, the polymeric material may be in various forms such as, for example, thread or strand, sponge, fabric, spatula, etc.

The term “polymer” is understood to mean a macromolecule exhibiting a repetitive chaining of one or more units called monomer(s). Thus, a polymer may be a copolymer, such as, for example, butadiene-acrylonitrile.

The term “prepolymer” shall be construed as a mixture of monomers and/or oligomers, intended to form a polymer.

The term “metal particles” shall be construed as a metal in the form of powder or crushed sheets, the dimensions of which are less than 100 µm, preferably less than 50 µm, more preferably less than 25 µm, even more preferably less than 10 µm. In particular, the size of the metal particles is preferably greater than 100 nm, more preferably greater than 600 nm, even more preferably greater than or of the order of 1 µm, such as of the order of 1 µm to 8 µm.

The terms “of the order of X” shall be construed as a value lying between plus or minus 10% of X.

When particle sizes are indicated in the instant application, they shall be construed as designating all of the particles being of the quoted size.

Advantageously, the size of the metal particles is determined by laser diffraction, preferably by applying the procedure described in the ASTM B822 standard. Advantageously, the metal particles are chosen from a group consisting of aluminum, silver, copper, titanium, palladium, stainless steel, lead, nickel, magnesium, iron, chromium, brass, nickel silver, cerium, platinum and/or gold particles, preferably aluminum, silver, copper, platinum and/or gold particles, more preferably aluminum, silver, copper and/or gold particles, even more preferably silver, copper and/or gold particles, for example silver particles.

When the metal particles are in powder form, they are preferably in the form of spheres, ellipses, pyramids, cylinders, cubes, rods and/or flakes, more preferably in the form of spheres and/or flakes. By way of example, spherical silver particles and flake shaped silver particles.

Alternatively, the metal particles may be in the form of ground sheets, such as, for example, ground copper or gold sheets.

Preferably, the metal particles (that is to say before acid treatment) have a purity greater than or equal to 90%, more preferably greater than or equal to 95%, even more preferably greater than or equal to 99%, such as, for example, equal to 99.99%. “Purity” means the percentage by mass of metal contained in the metal particles relative to the total mass of the metal particles. Thus, the metal particles, before treatment, are not grafted and do not comprise any amine or carboxylic acid.

It shall be noted that in the context of the instant application, and unless otherwise stipulated, the indicated ranges of values shall be construed as inclusive.

The term “acid treatment of metal particles” shall be construed as bringing said metal particles in contact with a Brønsted acid or a Lewis acid, preferably with a Brønsted acid. Advantageously, the acid used during the acid treatment step is an organic acid and/or an inorganic acid, preferably a carboxylic acid and/or an inorganic acid.

The term “carboxylic acid” shall be construed as a compound comprising at least one COOH group.

Preferably, the carboxylic acid is formic acid, acetic acid, propanoic acid, butanoic acid, pentanoic acid, hexanoic acid, heptanoic acid, citric acid and/or one or more fatty acids. The term “fatty acid” shall be construed as a carboxylic acid comprising from 8 to 24 carbon atoms, preferably from 12 to 20 carbon atoms, and having a saturated or unsaturated linear carbon chain.

Advantageously, the fatty acid can be obtained by heating a source of fatty acid(s), such as a vegetable oil. Preferably, the vegetable oil is rapeseed oil, avocado oil, olive oil, hazelnut oil, walnut oil, sunflower oil, palm oil, sesame oil and/or soybean oil, more preferably rapeseed oil, avocado oil, olive oil, hazelnut oil and/or walnut oil, even more preferably rapeseed oil.

More preferably, the carboxylic acid is acetic acid, citric acid and/or one or more fatty acids of rapeseed oil, even more preferably acetic acid and/or citric acid.

Preferably, the inorganic acid is sulfuric acid, phosphoric acid, nitric acid, hydrochloric acid, boric acid and/or hydrobromic acid, more preferably hydrochloric acid.

Thus, the acid used in the acid treatment step is preferably formic acid, acetic acid, propanoic acid, butanoic acid, pentanoic acid, hexanoic acid, heptanoic acid, citric acid, one or more fatty acids, preferably of a vegetable oil such as rapeseed oil, avocado oil, olive oil, hazelnut oil, walnut oil, sunflower oil, palm oil, sesame oil, soybean oil, sulfuric acid, phosphoric acid, nitric acid, hydrochloric acid, boric acid and/or hydrobromic acid, more preferably formic acid, acetic acid, propanoic acid, butanoic acid, pentanoic acid, hexanoic acid, heptanoic acid, citric acid, one or more rapeseed oil fatty acids, sulfuric acid, phosphoric acid, nitric acid, hydrochloric acid, boric acid and/or hydrobromic acid, even more preferably acetic acid, citric acid, hydrochloric acid and/or one or more fatty acids of rapeseed oil.

According to a first embodiment, the acid used during the acid treatment step is in aqueous solution. Preferably, the acid used according to this first embodiment is as described above, with the exception of vegetable oil fatty acids. Preferably, the aqueous solution comprises from 0.01% to 95% of acid, more preferably from 0.01% to 50% of acid, even more preferably from 1% to 25% of acid, such as, for example, from 5% to 10% of acid, by weight relative to the total weight of the aqueous solution.

According to a second embodiment, the acid used during the acid treatment step is one or more vegetable oil fatty acids as described above. According to this second embodiment, the vegetable oil is not diluted, in particular in an aqueous solution. According to a third embodiment, the acid used during the acid treatment step is not in the form of an aqueous solution, but in a pulverulent form (powder).

Advantageously, the acid treatment step is carried out with an acid mass ratio relative to the metal particles comprised between 0.5 and 10, preferably between 0.8 and 5, more preferably between 1 and 2, even more preferably of the order of 1.

It is understood that this mass ratio is calculated on the basis of the mass of pure acid. By way of example, mixing 5 g of metal particles with 100 g of an aqueous solution containing 5% of acid by weight, relative to the total weight of the aqueous solution, leads to an acid mass ratio of 1 relative to the metal particles.

Advantageously, the acid treatment step is carried out by heating the particles within the acid to a temperature less than or equal to the boiling temperature of the acid. Preferably, the temperature during the acid treatment step is comprised between the boiling point of the acid minus 20° C. and the boiling point of the acid, more preferably between the boiling point of the acid minus 10° C. and the boiling point of the acid, even more preferably between the boiling point of the acid minus 5° C. and the boiling point of the acid, such as, for example, of the order of the boiling point of the acid.

The term “boiling point of the acid” shall be construed as the boiling point of the acid in the form in which it is used, i.e., of the aqueous acid solution if it is diluted or of the vegetable oil in the case of one or more fatty acids of vegetable oil.

Advantageously, the acid treatment step is carried out until the acid has evaporated. The term “evaporation of the acid” shall be construed as at least 80% of the volume of acid being evaporated, preferably at least 85%, more preferably at least 90%.

When the method of the invention is carried out according to the third embodiment (acid in pulverulent form), the acid treatment step by heating is preferably carried out by mixing the metal particles with the acid in pulverulent form, for example in an amalgamator-mixer, the friction of the metal particles with the acid in the powder form generating a temperature rise. Preferably, the metal particles are mixed with the acid in a powder form at a speed greater than 100 rpm, more preferably greater than 200 rpm, even more preferably greater than 250 rpm, such as, for example, in the order of 300 rpm. Advantageously, the mixing step lasts at least 5 min, preferably at least 8 min, such as, for example, 10 min. This makes it possible to raise the temperature by friction, avoiding having to heat the mixture.

Advantageously, the method of the invention further comprises a step of washing the acid-treated metal particles with the aid of an aqueous washing solution. Preferably, the aqueous washing solution is water, in particular distilled water.

Advantageously, the method of the invention further comprises a step of recovering the metal particles at the end of the washing step, preferably by a filtration or a centrifugation step, more preferably a by filtration step. Preferably, the filtration step is carried out using a Büchner filter or a filter paper, more preferably using a filter paper. Preferably, the filtration step is carried out using a filter having a pore size comprised between 2 µm and 50 µm, more preferably between 8 µm and 40 µm, even more preferably between 17 µm and 30 µm. Following the washing step, the “wet” metal particles are forming agglomerates, allowing the use of a filter having a pore size greater than the size of a single particle.

Preferably, multiple washing steps of the treated metal particles and multiple recovering steps of the washed metal particles are carried out successively until the aqueous washing solution reaches a pH of approximately 6.5 to 7.5, preferably approximately 7. Advantageously, the method of the invention further comprises a step of drying the treated metal particles, preferably after the washing and recovery steps, by methods known to those skilled in the art. By way of example, the drying step may be carried out using an oven. This drying step has the advantage of breaking the agglomerates of metal particles and therefore makes it possible to produce non-agglomerated metal particles.

The metal particles thus treated are stable and can be stored in open air for at least 5 days before carrying out the step of mixing with a polymer or a prepolymer.

According to a preferred embodiment, the method of the invention further comprises the following steps: a step of washing the metal particles treated with acid using an aqueous washing solution, a step of recovering the metal particles at the end of the washing step, and a step of mixing the metal particles at the end of the recovery step with at least one polymer or prepolymer, preferably with at least one polymer.

The acid treatment, washing and filtration or centrifugation steps of the metal particles are advantageously as described above, including the embodiments.

Preferably, in the method of the invention, the step of mixing the treated metal particles with at least one polymer or prepolymer is carried out for at least 1 minute and at a speed comprised between 60 and 500 revolutions per minute (rpm), more preferably, for at least 2 minutes and at a speed comprised between 90 and 400 rpm, even more preferably, for 2 to 5 minutes and at a speed comprised between 120 and 300 rpm. Advantageously, the step of mixing the treated metal particles with at least one polymer or prepolymer is carried out with a concentration comprised between 0.001 % to 45% by weight of treated metal particles relative to the weight of the at least one polymer or prepolymer, preferably 0.001 % to 30% by weight, more preferably 0.005% to 25% by weight, even more preferably 0.01% to 20% by weight, for example 0.03% to 15% by weight.

Advantageously, the polymer(s) used for obtaining a polymeric material in the method of the invention is (are) chosen from the group consisting of polylactic acid (PLA), butadiene-based copolymers, styrenic polymers, polyamides (PA), polycarbonate (PC), polythiophenes (PT), polyalkylenes, polyesters, chloropolymers, polyurethane (PU) and silicone.

Preferably, the polymer(s) used in obtaining a polymeric material according to the method of the invention is (are) polylactic acid, acrylonitrile butadiene styrene (ABS), a polyamide such as, for example, nylon, polycarbonate, a polythiophene, polyethylene (PE), high-density polyethylene (HDPE), polypropylene (PP), polymethyl methacrylate (PMMA), polytetrafluoroethylene (PTFE), polyvinyl chloride (PVC), polyurethane (PU), in particular thermoplastic polyurethane (TPU), butadiene-acrylonitrile (NBR), styrene-butadiene (SBR), poly(styrene-butadiene-styrene) (SBS), polyethylene terephthalate (PET), polybutylene terephthalate (PBT) and/or silicone, in particular linear polydimethylsiloxane (PDMS). More preferably, the polymer(s) used is (are) thermoplastic polyurethane, butadiene-acrylonitrile, styrene-butadiene, polyethylene terephthalate, polybutylene terephthalate and/or linear polydimethylsiloxane, even more preferably thermoplastic polyurethane, butadiene-acrylonitrile and styrene-butadiene, polyethylene terephthalate, polybutylene terephthalate or linear polydimethylsiloxane. Advantageously, the prepolymer(s) used for obtaining a polymeric material according to the method of the invention is (are) intended to form a polymer chosen from the polymers mentioned above.

Preferably, the treated metal particles are mixed with at least one polymer. Advantageously, the method of obtaining a polymeric material according to the invention comprises a step of heating the polymer or prepolymer.

According to a particular embodiment, the method of the invention for obtaining a polymeric material comprises, when the polymer or the prepolymer are in particulate form (for example in the form of granules or powder) or in the liquid state at room temperature, a step of mixing the treated metal particles with said polymer or prepolymer followed by a step of heating the mixture of polymer or prepolymer and treated metal particles. The mixing step is advantageously performed as described above.

According to another particular embodiment, the method of the invention for obtaining a polymeric material comprises, when the polymer or the prepolymer is in the form of a monobloc (for example in the form of a plate) at room temperature, a step of heating the polymer or prepolymer until it melts, followed by a step of mixing the treated metal particles with said molten polymer or prepolymer. The mixing step is advantageously performed as described above.

Advantageously, the method of the invention for obtaining a polymeric material further comprises a step of shaping the polymeric material. This shaping step is known to those skilled in the art and may be, for example, shaping through a die, an extrusion, an injection, a thermoforming, a rotomolding, etc. Preferably, the shaping step is a performed through a die and/or an extrusion.

Advantageously, the method of the invention leads to the production of a polymeric material in the form of a yarn, fiber, sponge, spatula, tube, fabric or textile, especially in the form of a yarn or sponge, preferably in the form of a yarn, fiber, sponge, spatula, fabric or textile, more preferably in the form of a yarn, fiber, fabric or non-woven. Advantageously, the method of the invention leads to the production of a polymeric material with a thickness of less than 800 µm, preferably less than 500 µm, more preferably less than 250 µm, even more preferably less than 100 µm, such as for example between 5 µm and 70 µm.

According to a particular embodiment, the method of the invention further comprises a step of combining the polymeric material in the form of a yarn or fiber obtained previously with yarns or fibers of natural or synthetic origin, in order to obtain a fabric or a non-woven. Preferably, the yarns or fibers of natural origin are yarns or fibers of cotton, bamboo, linen, hemp, wool, silk and/or cashmere. Preferably, the yarns or fibers of synthetic origin are cellulose (for example, rayon), acrylic, polyolefin-based, polyurethane-based, polyvinyl-based, polyester-based or nylon-based yarns or fibers.

In a specific embodiment, the method of the invention for obtaining a polymeric material consists of the following steps:
a step of acid treatment of metal particles,
a step of washing the acid-treated metal particles with an aqueous washing solution,
a step of recovering the metal particles at the end of the washing step, - a step of drying the metal particles at the end of the recovery step, - a step of mixing the metal particles at the end of the drying step with at least one polymer or prepolymer, preferably with at least one polymer, - a step of heating the at least one polymer or prepolymer before, during or after the mixing step, - a step of shaping the polymeric material, and -optionally a step of combining the polymeric material in the form of a yarn or a fiber obtained previously with yarns or fibers of natural or synthetic origin, in order to obtain a fabric or a non-woven.

The steps of this specific embodiment are advantageously performed as described above, including the embodiments.

The invention also relates to a polymeric material which can be obtained by the method according to the invention.

Advantageously, the polymeric material which can be obtained by the method of the invention for obtaining a polymeric material is in the form of a yarn, sponge, spatula, tube, fabric or a non-woven, in particular in the form of a yarn or sponge, preferably in the form of a yarn, fiber, fabric or a non-woven.

Advantageously, the size of the metal particles in the polymeric material which can be obtained by the method of the invention is greater than 200 nm.

In particular, the size of the metal particles is preferably greater than 500 nm, more preferably greater than 800 nm, even more preferably greater or equal than 1 µm, such as of the order of 1 µm to 8 µm.

The polymeric material and the metal particles are as described above, including the embodiments, in particular the description of the polymer and of the prepolymer.

In addition, the invention relates to a polymeric material incorporating metal particles with a size greater than 100 nm, preferably greater than 200 nm, said metal particles being incorporated in the bulk of said polymeric material.

In particular, since the metal particles are incorporated in the bulk of said polymeric material, advantageously less than 20% of the metal particles are located on the surface of the polymeric material, preferably less than 10%, more preferably less than 5%, even more preferably 0%.

The expression “metal particles incorporated in the bulk of the polymeric material” shall be construed as the metal particles are distributed throughout the bulk of the polymeric material.

Unlike the polymeric material according to the invention, the polymeric materials obtained with untreated metal particles do not have any metal particles visible inside, after a transverse section of said polymeric material. In particular, the untreated metal particles are found at the periphery or at the surface of the bulk of the polymeric material. Thus, the washing or the wear of a polymeric material obtained with untreated metal particles will lead to the removal of the metal particles.

Advantageously, the concentration by weight of the metal particles in the polymeric material according to the invention is comprised between 0.001% and 45% relative to the weight of the polymer or polymers present in the polymeric material, preferably between 0.001% and 30% by weight, more preferably between 0.005% and 25% by weight, even more preferably between 0.01% and 20% by weight, for example between 0.03% and 15% by weight.

The polymeric material and the metal particles are as described above, including the embodiments, in particular for the particles size, the polymer, the prepolymer and the form of the material.

In particular, the polymeric material according to the invention is advantageously in the form of a yarn, fiber, sponge, spatula, tube, fabric or a non-woven, preferably, in the form of a yarn, fiber, sponge, spatula, fabric or a non-woven, more preferably, in the form of yarn, fiber, fabric or a non-woven.

In addition, the polymeric material according to the invention is advantageously of a thickness of less than 800 µm, preferably less than 500 µm, more preferably less than 250 µm, even more preferably less than 100 µm, such as for example between 5 µm and 70 µm.

The invention also relates to a fabric or a non-woven incorporating the polymeric material according to the invention.

Advantageously, the fabric or the non-woven according to the invention also comprises yarns or fibers of natural or synthetic origin. Preferably, the yarns or fibers of natural origin are yarns or fibers of cotton, bamboo, linen, hemp, wool, silk and/or cashmere. Preferably, the yarns or fibers of synthetic origin are cellulose (for example, rayon), acrylic, polyolefin-based, polyurethane-based, polyvinyl-based, polyester-based or nylon-based yarns or fibers.

The invention finally relates to the use of the polymeric material according to the invention as an antimicrobial agent, especially when the incorporated metal particles are silver, copper and/or gold particles.

The polymeric material according to the invention can advantageously be used in the agri-food field such as for a food packaging, a kitchen spatula, a kitchen mold, in the cosmetic field such as for a make-up brush, a make-up sponge, in the health field such as for a dressing, hospital linens and clothing (laboratory gown, medical clothing, a mask) or more generally for everyday tools such as a computer keyboard, a computer mouse, a telephone, an air filter, bed linen or a garment such as for example gloves, scarves or socks.

The present invention is illustrated, in a nonlimiting manner, by the following examples and the following figures:

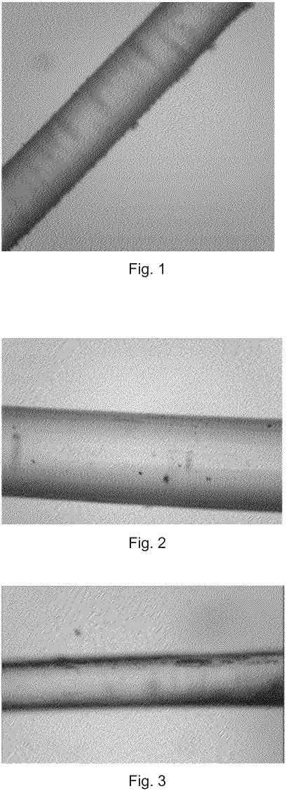

FIG. 1 is a photograph (lens MAGNIFICATION: × 10 and numerical aperture: 0.25) of a make-up brush bristle obtained according to the method described in Example 2, from unpretreated spherical silver particles with a size comprised between 1 and 3 µm and PBT 4000, the particle/PBT mass concentration being 1%.

FIG. 2 is a photograph (lens magnification: X10 and numerical aperture: 0.25) of a makeup brush bristle obtained according to the method described in Example 2, from spherical silver particles of a size comprised between 1 and 3 µm pretreated with acetic acid and PBT 4000, the mass concentration of particles/PBT being 1%.

FIG. 3 is a photograph (lens magnification: X10 and numerical aperture: 0.25) of a makeup brush bristle obtained according to the method described in Example 2, from non-pretreated spherical silver particles of a size comprised between 1 and 3 µm and PBT 4000, the mass concentration of particles/PBT being 0.16%.

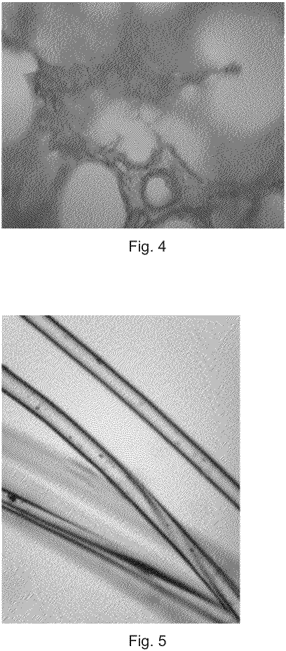

FIG. 4 is a photograph (lens magnification: X10 and numerical aperture: 0.25) of a make-up sponge obtained according to the process described in Example 3, from silver particles (flake) of a size comprised between 2 and 5 µm pretreated with acetic acid and a polymer mixture of NBR and SBR (NBR/SBR mass ratio equal to 0.25), the mass concentration of particles/polymer mixture being 0.067 %.

FIG. 5 is a photograph (lens magnification: X10 and numerical aperture: 0.25) of yarns obtained by the method described in Example 4 before mixing with other yarns (for example, cotton), from spherical silver particles of a size comprised between 1 and 3 µm pretreated with citric acid and PET, the mass concentration of particles/PET being 0.1%.

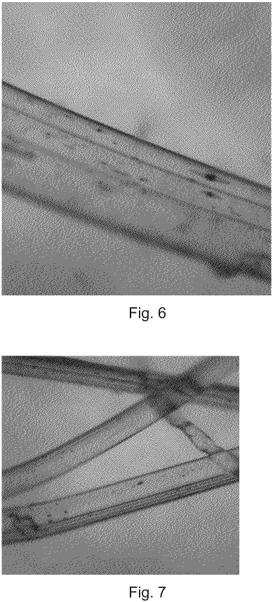

FIG. 6 is a photograph (lens magnification: X10 and numerical aperture: 0.25) of yarns obtained by the method described in Example 4 before mixing with other yarns (for example, cotton), from non-pretreated spherical silver particles of a size comprised between 1 and 3 µm and from PET, the mass concentration of particles/PET being 1%.

FIG. 7 is a photograph (lens magnification: X10 and numerical aperture: 0.25) of yarns obtained by the method described in Example 4 before mixing with other yarns (for example, cotton), from spherical silver particles of a size comprised between 1 and 3 µm pretreated with acetic acid and PET, the mass concentration of particles/PET being 1%.

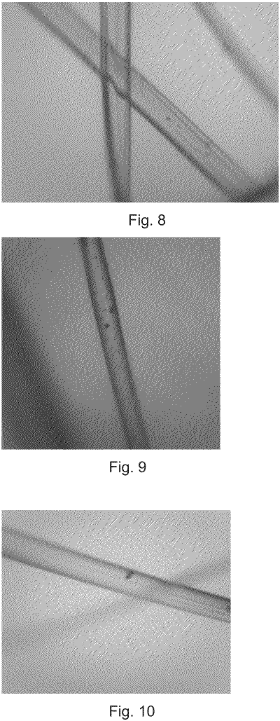

FIG. 8 is a photograph (lens magnification: X10 and numerical aperture: ) of yarns obtained by the method described in Example 4 before mixing with other yarns (for example, cotton), from spherical silver particles of a size comprised between 1 and 3 µm pretreated with hydrochloric acid and PET, the particle/PET mass concentration being 0.1%.

FIG. 9 is a photograph (lens magnification: X10 and numerical aperture: 0.25) of yarns obtained by the method described in Example 4 before mixing with other yarns (for example, cotton), from spherical silver particles of a size comprised between 1 and 3 µm pretreated with rapeseed oil and PET, the particle/PET mass concentration being 0.1%.

FIG. 10 is a photograph (lens magnification: X40 and numerical aperture: 0.65) of yarns obtained by the method described in Example 4 before mixing with other yarns (for example, cotton), from ground copper sheets with a length comprised between 1 and 8 µm pretreated with acetic acid and PET, the mass concentration of particles/PET being 0.1%.

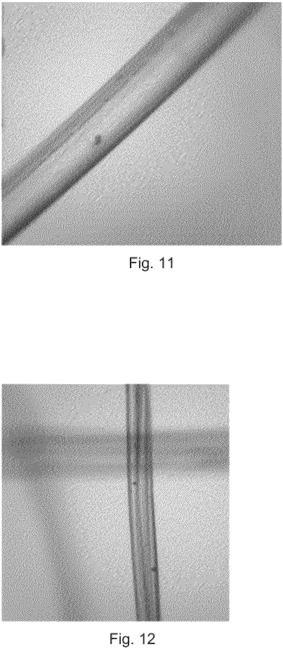

FIG. 11 is a photograph (lens magnification: X10 and numerical aperture: 0.25) of yarns obtained by the method described in Example 4 before mixing with other yarns (for example, cotton), from a ground gold leaf with a length comprised between 1 and 8 µm pretreated with acetic acid and PET, the mass concentration of particles/PET being 0.1%.

FIG. 12 is a photograph (lens magnification: X10 and numerical aperture: 0.25) of yarns obtained by the method described in Example 4 before mixing with other yarns (for example, cotton), from spherical silver particles of a size approximately equal to 200 nm pretreated with acetic acid and PET, the mass concentration of particles/PET being 0.1%.

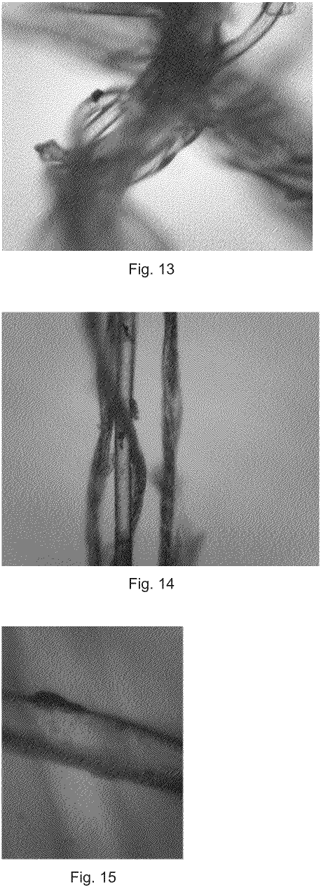

FIG. 13 is a photograph (lens magnification: X10 and numerical aperture: 0.25) of yarns obtained by the method described in Example 4 after braiding with cotton yarns, from non-pretreated spherical silver particles of a size comprised between 1 and 3 µm and of PET, the mass concentration of particles/PET being 0.1%.

FIG. 14 is a photograph (lens magnification: X10 and numerical aperture: 0.25) of yarns obtained by the method described in Example 4 after braiding with cotton yarns, from spherical silver particles of a size comprised between 1 and 3 µm pretreated with acetic acid and of PET, the mass concentration of particles/PET being 4%.

FIG. 15 is a photograph (lens magnification: X4 and numerical aperture: 0.10) of a PET yarn comprising silver particles sold under the name X-STATIC®.

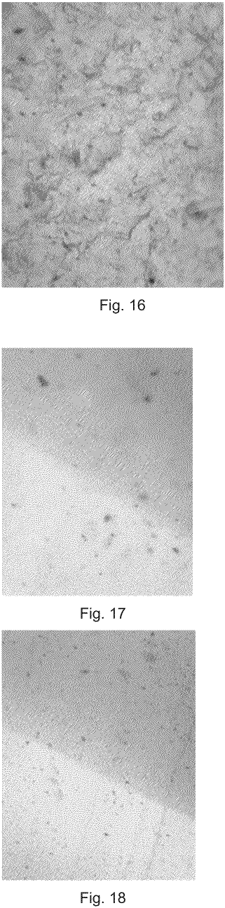

FIG. 16 is a photograph (lens magnification: X10 and numerical aperture: 0.25) of a silicone spatula obtained by the method described in Example 5, from silver particles (flake) of a size comprised between 2 and 5 µm pretreated with acetic acid and silicone, the particle/silicone mass concentration being 1%.

FIG. 17 is a photograph (lens magnification: X10 and numerical aperture: 0.25) of a silicone spatula obtained by the method described in Example 5, from silver particles (flake) of a size comprised between 2 and 5 µm pretreated with citric acid and silicone, the particle/silicone mass concentration being 1%.

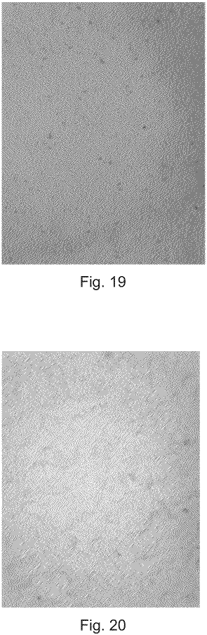

FIG. 18 is a photograph (lens magnification: X10 and numerical aperture: 0.25) of a silicone spatula obtained by the method described in Example 5, from silver particles (flake) of a size comprised between 2 and 5 µm pretreated with citric acid and silicone, the particle/silicone mass concentration being 5%

FIG. 19 is photograph of a cross section (lens magnification: X10 and numerical aperture: 0.25) of a silicone spatula obtained by the method described in Example 5, from spherical silver particles of a size comprised between 1 and 3 µm pretreated with citric acid and silicone, the particle/silicone mass concentration being 1%.

FIG. 20 is a photograph (lens magnification: X10 and numerical aperture: 0.25) of a cross section of a silicone spatula obtained by the method described in Example 5, from non-pretreated spherical silver particles of a size comprised between 1 and 3 µm and of silicone, the mass concentration of particles/silicone being 1%.

### EXAMPLE 1: METHOD FOR TREATING METAL PARTICLES

Metal particles (Atlantic Equipment Engineers, Micron Metals Inc., with a 99.99% purity) are introduced into a bath of aqueous acid solution, with a particle/acid mass ratio equal to 1, then mixed with the aid of a glass rod so that they are completely impregnated with the solution.

Alternatively, metal particles (Atlantic Equipment Engineers, Micron Metals Inc.) are introduced into a rapeseed oil bath, the particle/oil mass ratio being equal to 1, then mixed using a glass rod so that they are completely impregnated with oil.

Alternatively, the metal particles (Atlantic Equipment Engineers, Micron Metals Inc.) are mixed with a powdered acid for 10 minutes using an amalgamator-mixer at a speed of 300 revolutions per minute (rpm), the particle/acid mass ratio being equal to 1. Friction generates a temperature rise.

The bath is then heated to a temperature dependent on the used acid or on the oil used until evaporation of the solution to obtain wet particles:
acetic acid: about 118° C.,
citric acid: about 175° C.,
hydrochloric acid: about 109° C.,
rapeseed oil: between 180 and 232° C.

The latter are then washed with distilled water and then filtered on a filter paper (pore size between 17 and 30 µm) successively until a neutral pH (pH of approximately 7) is obtained.

They are then dried in an oven at 60° C. for at least 1 hour.

Once dry, these particles can be stored in open air for at least 5 days without affecting the rest of the process.

In Examples 2 to 5 below, all the analyses were carried out using a microscope (Senecope Lab Binocular compound 40 × 2500 × LED).

### EXAMPLE 2: METHOD OF MANUFACTURING BRISTLES FOR MAKEUP BRUSHES

The metal particles obtained according to the method described in Example 1 (use of an aqueous acid solution) are mixed with granules of PBT 4000 (Chang Chun Chemical Ltd China) using an amalgamator-mixer at a speed of 150 revolutions per minute (rpm) for 2 to 5 minutes. The mixture is then melted at 255° C.

The molten mixture is passed through an extruder, then through a die and finally cooled in a water bath in order to obtain yarns of 0.06 mm in diameter.

The yarns are then left to air-dry and will serve as bristles for makeup brushes.

Various tests were carried out by varying the source of the metal particles as well as the quantities of metal particles and of PBT and are summarized in Table 1, the concentration by mass of particles/PBT representing the ratio by mass of metal particles/PBT before their mixing.

TABLE 1

| Trial | Particle Source | Particle mass | PBT mass | Particle/PBT mass concentration |
|---|---|---|---|---|
| A | Silver, spherical 1-3 µm without treatment | 10 g | 1 kg | 1% |
| B | Silver, spherical 1-3 µm, acetic acid | 10 g | 1 kg | 1% |
| C | Silver, spherical 1-3 µm without treatment | 8 g | 5 kg | 0.16% |

The yarns obtained according to trials A and C were analyzed by microscope, the results being shown in FIG. 1 for trial A and in FIG. 3 for trial C. Furthermore, the results of trial B are shown in FIG. 2. The comparison of these figures highlights the incorporation of the metal particles inside the polymer yarn only if they underwent beforehand a treatment according to the method of Example 1 (FIG. 2). Indeed, the particles remain on the surface of the polymer yarn when they did not undergo the method of Example 1, which confers a granulous aspect to the yarn, shown in FIG. 1 and FIG. 3. In addition, FIG. 3 shows the presence of notches in the polymer, around the particles, that are not observed in FIG. 2.

### EXAMPLE 3: METHOD FOR MANUFACTURING MAKE-UP SPONGES

Different polymers are used in this example: NBR liquid (for “Nitrile Butadiene Rubber”) and SBR liquid (for “Styrene Butadiene Rubber”), both supplied by Aero Rubber Company, or polyurethane with an additive composed of wollastonite powder, silane and water.

The metal particles obtained by the method described in Example 1 (use of an aqueous acid solution) are mixed with various polymers using an amalgamator-mixer at a speed of 300 rpm for 2 to 5 minutes. The mixture is then melted at 90° C. and then poured into molds.

The molds are then cooled to 10° C. by a water flow, which allows the formation of the sponge structure.

The sponges are then cut and polished.

The conditions of the various trials carried out are summarized in Table 2, the particle/polymer mixture mass concentration representing the metal particle/polymer mixture mass ratio before mixing.

TABLE 2

| Trial | Particle Source | Particle mass | Mass of NBR | Mass of SBR | Polyurethane mass | Additive | Particle/polymer mixture mass concentration |
|---|---|---|---|---|---|---|---|
| D | Silver, flake 2-5 µm , acetic acid | 10 g | 3 kg | 12 kg | - | - | 0.067% |
| E | Silver, flake 2-5 µm , acetic acid | 7.5 g | 3 kg | 12 kg | - | - | 0.05% |
| F | Silver, spherical 1-3 µm, acetic acid | 10 g | - | - | 15 kg | 15 kg | 0.033% |
| G | Silver, flake 2-5 µm , acetic acid | 30 g | - | - | 15 kg | 15 kg | 0.1% |

The sponges obtained according to trials D to G were analyzed by microscope. These have all a similar structure, an example of which is shown in FIG. 4. This figure shows that, for different polymer mixtures, the metal particles are incorporated inside the polymer mixture, independently of the shape of the particles.

### EXAMPLE 4: METHOD FOR MANUFACTURING YARNS FOR OBTAINING A FABRIC

The metal particles obtained according to the process described in Example 1 (use of an aqueous solution of acid or oil for trial L) are mixed with polyethylene terephthalate or “PET” granules (supplier: Techmer PM) using an amalgamator-mixer at a speed of 150 rpm for 2 to 5 minutes.

The mixture is conveyed at 315° C. by a worm to a die and finally cooled by thermal shock in order to obtain transparent strands. These strands are combined into yarns of about 10 µm in diameter.

The yarns are then left to dry in the open air and may then be mixed with other yarns, for example of cotton, with the aim to obtaining a fabric, for example by braiding.

Various trials were carried out by varying the source of the metal particles as well as the quantities of metal particles and of PET and are summarized in Table 3, the mass concentration of particles/PET representing the mass ratio of metal particles/PET before their mixture.

TABLE 3

| Trial | Particle Source | Particle mass | Mass of PET | Particle/PBT mass concentration |
|---|---|---|---|---|
| H | Silver, spherical 1-3 µm without treatment | 10 g | 1 kg | 1% |
| I | Silver, spherical 1-3 µm, acetic acid | 10 g | 1 kg | 1% |
| J | Silver, spherical 1-3 µm, citric acid | 1 g | 1 kg | 0.1% |
| K | Silver, spherical 1-3 µm , hydrochloric acid | 1 g | 1 kg | 0.1% |
| L | Silver, spherical 1-3 µm , rapeseed oil | 1 g | 1 kg | 0.1% |
| M | Ground copper sheets, length 1-8 µm, acetic acid | 1 g | 1 kg | 0.1% |
| N | Ground gold sheets, length 1-8 µm, acetic acid | 1 g | 1 kg | 0.1% |
| O | Silver, spherical 200 nm, acetic acid | 1 g | 1 kg | 0.1% |
| P | Silver, spherical 1-3 µm without treatment | 1 g | 1 kg | 0.1% |
| Q | Silver, spherical 1-3 µm, acetic acid | 40 g | 1 kg | 4% |

The yarns obtained according to trials H (comparative), I and J were analyzed by microscope, the results being shown in FIGS. 6, 7 and 5 respectively.

FIG. 6 shows the presence of notches in the polymer, around the particles, which are not observed in FIG. 7 or in FIG. 5. In addition, the surface of the polymer in FIG. 6 is irregular, unlike the polymer in FIGS. 7 or 5.

By way of comparison, a PET yarn comprising silver particles sold under the name X-STATIC ® was analyzed by microscope (FIG. 15). This FIG. 15 clearly shows that the silver particles are not incorporated inside the polymer but are located on its surface. FIGS. 8 to 12, obtained for particles pretreated according to the invention (trials K to O respectively), show results similar to FIGS. 5 and 7.

These differences demonstrate that the metal particles are incorporated inside the polymer only in the case where they have previously undergone a treatment according to the method of Example 1. The yarns obtained according to trials P and Q were then braided with cotton yarns (FIGS. 13 and 14 respectively).

The differences are significant: FIG. 13 shows that the particles are on the surface of the polymer, while they are incorporated into the polymer in FIG. 14.

### EXAMPLE 5: METHOD FOR MANUFACTURING A SILICONE ARTICLE

Silicone plates (polydimethylsiloxane) are melted at a temperature comprised between 50 and 1185° C. then the metal particles obtained by the method described in Example 1 (use of an aqueous acid solution) are added and the medium is homogenized using an amalgamator-mixer at a rate of 120 rpm for 2 to 5 minutes.

The mixture is then poured into molds and allowed to cool to room temperature.

The conditions of the different trials carried out are summarized in Table 4.

TABLE 4

| Trial | Particle Source | Particle mass | Silicone mass | Particulate/silicone mass concentration |
|---|---|---|---|---|
| R | Silver, flake 2-5 µm, acetic acid | 10 g | 1 kg | 1% |
| S | Silver, flake 2-5 µm, citric acid | 10 g | 1 kg | 1% |
| T | Silver, flake 2-5 µm, citric acid | 50 g | 1 kg | 5% |
| U | Silver, spherical 1-3 µm, citric acid | 10 g | 1 kg | 1% |
| V | Silver, spherical 1-3 µm without treatment | 10 g | 1 kg | 1% |

The articles obtained according to the R to U trials were analyzed by microscope, the results being shown in particular in FIGS. 16 to 19. These figures show that, for different particle/silicone concentrations, the metal particles are well incorporated inside the silicone, regardless of the acid used to treat the metal particles before their incorporation.

In addition, contrary to what is observed for FIG. 19 (trial U) the particles present on the surface of the silicone of FIG. 20 (trial V) disappear in 3D.

### EXAMPLE 6 ASSESSMENT OF THE ANTIMICROBIAL ACTIVITY OF MAKEUP BRUSH BRISTLES ESCHERICHIA COLI

Makeup brush bristles obtained by the method described in Example 1 (silver, spherical 1-3 microns, acetic acid) and by the method described in Example 2 (mass concentration particles / PBT equal to 0.1 %), from the treated particles according to the invention, were tested to determine their antimicrobial activity according to the method described in ASTM E2149-13 (“Standard Test Method for Determining the Antimicrobial Activity of Immobilized Antimicrobial Agent Under Dynamic Contact Conditions”).

This method makes it possible to assess the resistance of samples treated with a non-leachable antimicrobial to the development of microbes under dynamic contact conditions.

Antimicrobial activity was determined by shaking 1 g of the above-mentioned bristles in a bacterial suspension inoculated with 2.48.10⁵ cfu/mL of Escherichia coli (ATCC 25922) for 1 hour at room temperature (23 ± 2° C.).

The results (mean values) for control broth and bristles (polymeric material) are shown in Table 5.

TABLE 5

| | | | |
|---|---|---|---|
| Sample | Control broth | | Polymeric material |
| Time | 0 | 1 hour | 1 hour |
| E. coli (cfu*/mL) | 2.61 10⁵ | 3.35 10⁵ | 1.78 10¹ |

* Colony Forming Unit

Thus, the use of bristles obtained by the methods described in Examples 1 and 2 allows a reduction of 99.99% of the number of bacteria.

These results highlight the strong antimicrobial activity of the polymeric material obtained from the treated particles according to the invention.

### EXAMPLE 7 ASSESSMENT OF THE ANTIMICROBIAL ACTIVITY OF MAKEUP BRUSH BRISTLES STAPHYLOCOCCUS AUREUS

PBT makeup brush bristles obtained from particles treated according to the methods described in Examples 1 and 2 (spherical silver particles 1-3 microns, acetic acid), with a mass concentration / PBT of 1%, were tested to determine their antimicrobial activity according to the method described in ASTM E2180 (“Standard method for Determining the Antimicrobial Activity of Incorporated Antimicrobial Agent (s) in Polymeric or Hydrophobic Material”).

This method makes it possible to assess the resistance of polymeric samples treated with an antimicrobial to the development of microbes under dynamic contact conditions. The antimicrobial activity was determined by contacting 3 × 3 cm flattened samples of the above-mentioned bristles with an agar agar gel inoculated with 1-5 × 10⁶ cells/mL of Staphylococcus aureus (ATCC 6538) for 24 hours in an incubator at a temperature of 35° C. under aerobic conditions.

The results (mean values) for the control sample and the bristles (polymeric material) are shown in Table 5.

TABLE 6

| Sample | Contact time | Replica | cfu/ml | S. aureus (Avg) | Decrease percentage |
|---|---|---|---|---|---|
| Control | 0 h | 1 | 1.09×10⁶ | | |
| | | 2 | 1.08×10⁶ | 1.083×10⁶ | - |
| | | 3 | 1.08×10⁶ | | |
| Control | 24 h | 1 | 4.4×10⁶ | | |
| | | 2 | 6.2×10⁶ | 5.57x10⁶ | - |
| | | 3 | 6.1×10⁶ | | |
| Polymeric material | 24 h | 1 | 2.6×10³ | | |
| | | 2 | 7.75×10³ | 4.23×10³ | 99.92% |
| | | 3 | 2.35×10³ | | |

Thus, the use of the bristles obtained in Example 2 allows a reduction of 99.92% of the number of bacteria Staphylococcus aureus ATCC #6538.

These results highlight the strong antimicrobial activity of the polymeric material obtained from the treated particles according to the invention.

### EXAMPLE 8 ASSESSMENT OF THE ANTIMICROBIAL ACTIVITY OF MAKEUP BRUSH BRISTLES PSEUDOMONAS AERUGINOSA

PBT make-up brush bristles obtained according to the methods described in Example 1 (1-3 µm spherical silver particles, citric acid) and in Example 2 (particle/PBT mass concentration equal to 1%) have been tested to determine their antimicrobial activity by following the method described in ASTM E2149-13 (“Standard Test method for Determining the Antimicrobial Activity of Immobilized Antimicrobial Agents Under Dynamic Contact Conditions”).

This method makes it possible to assess the resistance of samples treated with a non-leachable antimicrobial to the development of microbes under dynamic contact conditions.

Antimicrobial activity was determined by shaking 1 g of the above-mentioned bristles in a bacterial suspension inoculated with 6.60 10⁵ cfu/mL of Pseudomonas aeruginosa (ATCC 15442) for 1 hour at room temperature (23 ± 2° C.).

The results (mean values) for the control broth and the bristles (polymeric material) are shown in Table 7.

TABLE 7

| Sample | Control broth | | Polymeric material |
|---|---|---|---|
| Time | 0 | 1 hour | 1 hour |
| Pseudomonas aeruginosa (cfu*/mL) | 6.05×10⁵ | 3.45×10⁵ | 2.24×10⁴ |

* Colony Forming Unit

Thus, the use of bristles obtained by the methods described in Examples 1 and 2 allows a reduction of 93.51% of the number of bacteria Pseudomonas aeruginosa (ATCC 15442).

These results highlight the strong antimicrobial activity of the polymeric material obtained from the treated particles according to the invention.

### EXAMPLE 9: ASSESSMENT OF THE ANTIMICROBIAL ACTIVITY OF YARNS FOR THE PRODUCTION OF A FABRIC:

### Escherichia Coli

Yarns for obtaining a fabric obtained from particles treated according to the invention (silver, spherical 1-3 µm, acetic acid) and according to the method described in Example 4 (particle/PET mass concentration of 4%) were tested to determine their antimicrobial activity by following the method described in ASTM E2180 (“Standard method for Determining the Antimicrobial Activity of Incorporated Antimicrobial Agent(s) in Polymeric or Hydrophobic Material”).

This method makes it possible to assess the resistance of polymeric samples treated with an antimicrobial to the development of microbes under dynamic contact conditions. The antimicrobial activity was determined by contacting 3 × 3 cm flattened samples of the above-mentioned yarns with an agar agar gel inoculated with 1-5 × 10⁶ cells/mL of Escherichia Coli (ATCC 8739) for 24 hours in an incubator at a temperature of 35° C. under aerobic conditions.

The results (mean values) for the control sample and the yarns (polymeric material) are shown in Table 8.

TABLE 8

| Sample | Contact time | Replica | cfu/ml | E. coli (Avg) | Decrease percentage |
|---|---|---|---|---|---|
| Control | 0 h | 1 | 1.21×10⁶ | 1.66×10⁶ | - |
| | | 2 | 2.02×10⁶ | | |
| | | 3 | 1.88×10⁶ | | |
| Control | 24 h | 1 | 6.20×10⁶ | 1.21×10⁷ | - |
| | | 2 | 1.68×10⁷ | | |
| | | 3 | 1.69×10⁷ | | |
| Polymeric material | 24 h | 1 | <10 | <10 | 99.9999% |
| | | 2 | <10 | | |
| | | 3 | <10 | | |

Thus, the use of yarns obtained by the methods described in Examples 1 and 4 allows a reduction of 99.9999% of the number of Escherichia Coli (ATCC 8739) bacteria.

These results highlight the strong antimicrobial activity of the polymeric material obtained from the treated particles according to the invention.

1-11. (canceled)

12. A method for obtaining a polymeric material incorporating metal particles comprising steps of:
acid treating the metal particles, and
mixing the acid treated metal particles with at least one polymer according to a mass concentration of a mass of treated metal particles relative to a mass of the at least one polymer, comprised between 0.001% and 45%.

13. The method of claim 12, wherein an acid used in the acid treating step is a carboxylic acid.

14. The method of claim 12, wherein an acid used in the step of acid treating is an inorganic acid.

15. The method of claim 13 or claim 14, wherein the acid used in the step of acid treating is selected from a group consisting of formic acid, acetic acid, propanoic acid, butanoic acid, pentanoic acid, hexanoic acid, heptanoic acid, citric acid, a fatty acid, sulfuric acid, phosphoric acid, nitric acid, hydrochloric acid, boric acid and hydrobromic acid.

16. The method of claim 13 or claim 14, wherein the acid used in the step of acid treating is selected from a group consisting of acetic acid, citric acid, hydrochloric acid and a fatty acid of rapeseed oil.

17. The method according to claims 12, wherein the step of acid treating is carried out with a mass ratio of an acid relative to the metal particles comprised between 0.5 and 10.

18. The method of claim 12, wherein the step of acid treating is carried out by heating the metal particles within an acid to a temperature less than or equal to a boiling temperature of the acid.

19. The method of claim 12, further comprising the steps of:
washing the metal particles treated with acid using an aqueous washing solution,
recovering the metal particles after the step of washing the metal particle, and
a step of mixing the metal particles with the at least one polymer after the step of recovering the metal particles.

20. The method of claim 12, wherein the metallic particles are selected from a group consisting of particles of aluminum, silver, copper, titanium, palladium, stainless steel, lead, nickel, magnesium, iron, chromium, brass, copper-zinc alloy, cerium, platinum and gold.

21. A method for obtaining a polymeric material incorporating metal particles comprising steps of:
acid treating the metal particles, and
mixing the acid treated metal particles with at least one polymer according to a mass concentration of a mass of treated metal particles relative to a mass of the at least one prepolymer, comprised between 0.001% and 45%.

22. A polymeric material obtainable by the method of claim 12 or the method of claim 21.

23. A polymeric material incorporating metallic particles of a size greater than 200 nm, the metallic particles being incorporated into the bulk of the polymeric material.

24. A use of the polymeric material of claim 22, as an antimicrobial agent.

25. A use od the polymeric material of claim 23, as an antimicrobial agent.
